(19) United States
(12) Patent Application Publication
(10) Pub. No.: US 2026/0138735 A1
(43) Pub. Date: May 21, 2026

(54) Locking Electromechanical Actuator with Pneumatic Backup

(71) Applicant: Textron Aviation Inc., Wichita, KS (US)

(72) Inventors: Michael Haugen, Edmonds, WA (US); Justin Jirik, Goddard, KS (US); Donald Edward Hill, Wichita, KS (US); Robin L. Young, Wichita, KS (US); Jeremy Phillip Taylor, Bel Aire, KS (US)

(21) Appl. No.: 19/034,474

(22) Filed: Jan. 22, 2025

Related U.S. Application Data
(60) Provisional application No. 63/623,694, filed on Jan. 22, 2024.

(51) Int. Cl. B64C 25/30; B64C 25/22; B64C 25/24

(52) U.S. Cl. CPC B64C 25/30; B64C 25/24; B64C 25/22

(57) ABSTRACT

A linear actuator may include a piston and a linear drive. The piston is slidably mounted for sliding along an axis. The linear drive includes a ball screw and a ball nut operably mounted on the ball screw, with rotation of the ball screw causing the ball nut to move axially along the ball screw. The piston is attached to the ball nut, and the piston is configured to be advanced along the axis as the ball screw is rotated.

### BACKGROUND

### CROSS-REFERENCE TO RELATED APPLICATIONS

This application claims the benefit of U.S. Provisional Patent Application No. 63/623,694, filed Jan. 22, 2024, the entire contents thereof are herein incorporated by reference.

### 1. FIELD

Embodiments of the invention relate generally to actuator devices, and more specifically to blow-down actuators used in aircraft landing gear.

### 2. RELATED ART

Blow down actuators found in the prior art use a primary drive mechanism to extend an aircraft landing gear during normal operation and a backup system to extend and retract the aircraft landing gear during an emergency. For example, U.S. Pat. No. 9,790,969 to Fenn et al. discloses an electromechanical drive mechanism that provides a primary drive and a backup system operated by a gas generator. U.S. Pat. No. 10,458,442 to Fenn et al. ; U.S. Pat. No. 10,683,880 to Fenn et al. ; and U.S. Pat. No. 10,920,801 to Fenn et al. also disclose an electromechanical drive mechanism that provides a primary drive and a backup system operated by a gas generator.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a linear actuator broadly includes a piston, a drive mechanism, a linear drive, and a releasable coupling. The piston is slidably mounted for sliding along an axis. The linear drive includes a ball screw and a ball nut operably mounted on the ball screw, with rotation of the ball screw causing the ball nut to move axially along the ball screw. The drive mechanism includes a rotational drive element operable to impart rotation to the ball screw about the axis. The piston is attached to the ball nut, with the ball nut and piston configured to be advanced along the axis as the ball screw is rotated. The releasable coupling drivingly interconnects the drive mechanism and ball screw, with rotation of the drive element causing rotation of the ball screw. The releasable coupling is releasably attached to one of the drive element and the ball screw to permit relative movement between the drive element and the ball screw.

In another embodiment, a blow-down actuator broadly includes an actuator cylinder, a piston, a linear drive, and a drive mechanism. The piston is slidably mounted for sliding along an axis. The linear drive includes a ball screw and a ball nut operably mounted on the ball screw, with rotation of the ball screw causing the ball nut to move axially along the ball screw. The drive mechanism includes a rotational drive element operable to impart rotation to the ball screw about the axis. The piston is attached to and receives the ball nut, with the ball nut and piston configured to be advanced along the axis as the ball screw is rotated. The ball nut includes a body and wipers attached to the body at opposite ends of the body. The wipers slidably engage the ball screw to contain bearing balls between the body and the ball screw, with the wipers at least partly forming a flow restriction that limits pressurized gas bleed axially through the ball nut.

In another embodiment, a linear actuator broadly includes a piston and a linear drive. The piston is slidably mounted for sliding in a distal direction to extend the piston and in a proximal direction to retract the piston. The linear drive includes a ball screw and a ball nut operably mounted on the ball screw, with rotation of the ball screw causing the ball nut to move axially along the ball screw. The piston includes a piston section with proximal and distal stops and a piston chamber extending between the proximal and distal stops to receive the ball nut. The ball nut is distally shiftable to engage the distal stop and move the piston in the distal direction. The ball nut is proximally shiftable to engage the proximal stop and move the piston in the proximal direction.

### BRIEF DESCRIPTION OF THE DRAWING FIGURES

Embodiments of the invention are described in detail below with reference to the attached drawing figures, wherein:

FIGS. 1-3 are views of a blow-down actuator including an actuator housing, a powered drive mechanism, a piston assembly, a down-lock indicator, a linear drive, and a releasable coupling, and showing the piston assembly in retracted and extended positions;

FIG. 4 is a cross-sectional view of a motor of the powered drive mechanism shown in FIGS. 1-3;

FIGS. 5 and 6 are views of a transmission of the powered drive mechanism shown in FIGS. 1-3, showing a gear drive housed in a gearbox of the transmission;

FIG. 7 is a fragmentary cross-sectional view of the blow-down actuator shown in FIGS. 1-3, showing the piston assembly retracted within an actuator cylinder and the linear drive engaged with the gear drive and the piston assembly;

FIGS. 8-11 are views of the piston assembly and the linear drive shown in FIGS. 1-3;

FIGS. 12 and 13 are views of the linear drive shown in FIGS. 1-3, showing a ball nut and ball screw of the linear drive;

FIGS. 14-16 are fragmentary views of the blow-down actuator shown in FIGS. 1-3, showing the piston assembly in retracted and extended positions, and further depicting a piston locking device in locked and unlocked positions when the piston assembly is extended;

FIGS. 17-19 are views of the releasable coupling and linear drive shown in FIGS. 1-3, showing a collet removably engaged with the ball screw by a collet lock;

FIGS. 20-23 are views of the blow-down actuator shown in FIGS. 1-3, showing engagement of a pneumatic system to facilitate secondary blow-down operation of the actuator to extend the piston assembly;

FIGS. 24 and 25 are views of the blow-down actuator shown in FIGS. 1-3, showing the use of lock release pins after secondary blow-down operation to release the piston locking device and enable the piston assembly to be returned to the retracted position; and

FIGS. 26-31 are views of the blow-down actuator shown in FIGS. 1-3, showing the use of pressurized gas flow to unlock the piston locking device and enable the piston assembly to be returned to the retracted position.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aircraft utilize a powered actuator as part of a landing gear mechanism to raise and lower the wheels of the landing gear. Upon liftoff of the aircraft, the landing gear may be retracted from a deployed condition to a stowed condition. Conversely, in preparation for landing of the aircraft, the landing gear may be extended so that the wheels are deployed for touchdown.

A landing gear actuator may include a primary actuation mode and a secondary (emergency) actuation mode. The secondary actuation mode may be provided by a redundant actuator mechanism to ensure reliable extension of the landing gear under adverse conditions. In particular, the redundant actuator mechanism for extending the landing gear is typically engaged when the primary actuator mechanism experiences some type of failure, such as a power failure or a geartrain failure, that renders the primary actuator mechanism unable to complete the process of deploying the landing gear.

In some embodiments, a landing gear actuator may comprise a blow-down actuator that uses hydraulic power for primary actuation and pneumatic power for secondary actuation. The actuator may have a hydraulic drive system and an integrated backup system operated by a gas generator. Another blow-down actuator may utilize electromechanical power for primary actuation.

Embodiments of the present disclosure comprise a blow-down actuator that facilitates efficient and robust control of the landing gear. Specifically, the blow-down actuator has a retracted position, associated with retraction (and stowing) of the landing gear, and an extended position, associated with extension (and deployment) of the landing gear. The actuator may have a releasable coupling that reliably responds to an emergency situation to permit “blow-down” operation of the actuator for shifting the actuator into the extended position so that the landing gear is deployed. The actuator may also facilitate smooth extension of the landing gear during blow-down through effective snubbing of actuator piston motion. Further, aspects of the actuator may provide positive locking indication of the landing gear subsequent to blow-down actuation.

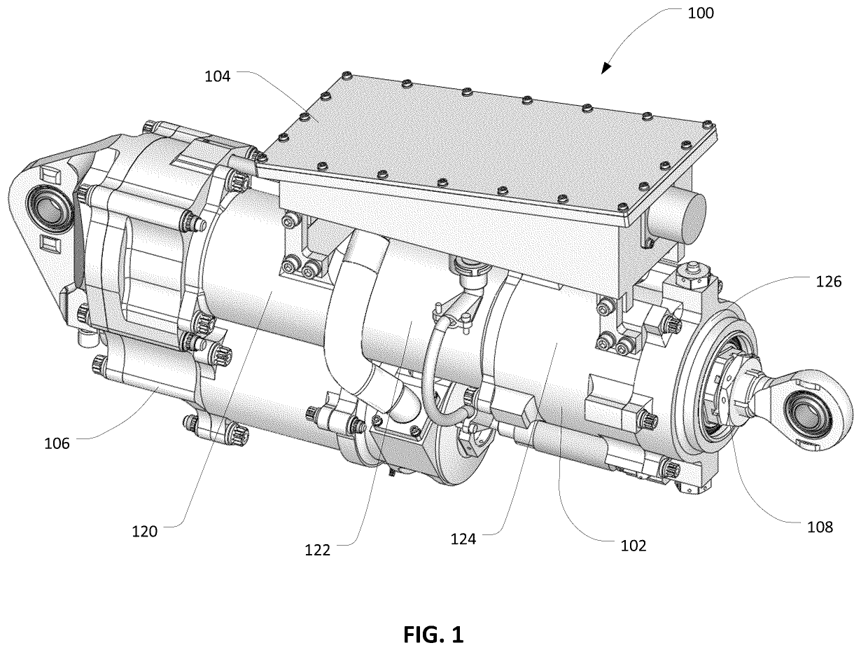

Turning initially to FIGS. 1-3, a blow-down actuator 100 may include a primary, electromechanical, actuation mode and a secondary, pneumatic, actuation mode powered by compressed nitrogen. The actuator 100 broadly includes an actuator housing 102, a controller 104, a powered drive mechanism 106, a piston assembly 108, a down-lock indicator 110, a linear drive 112, and a releasable coupling 114.

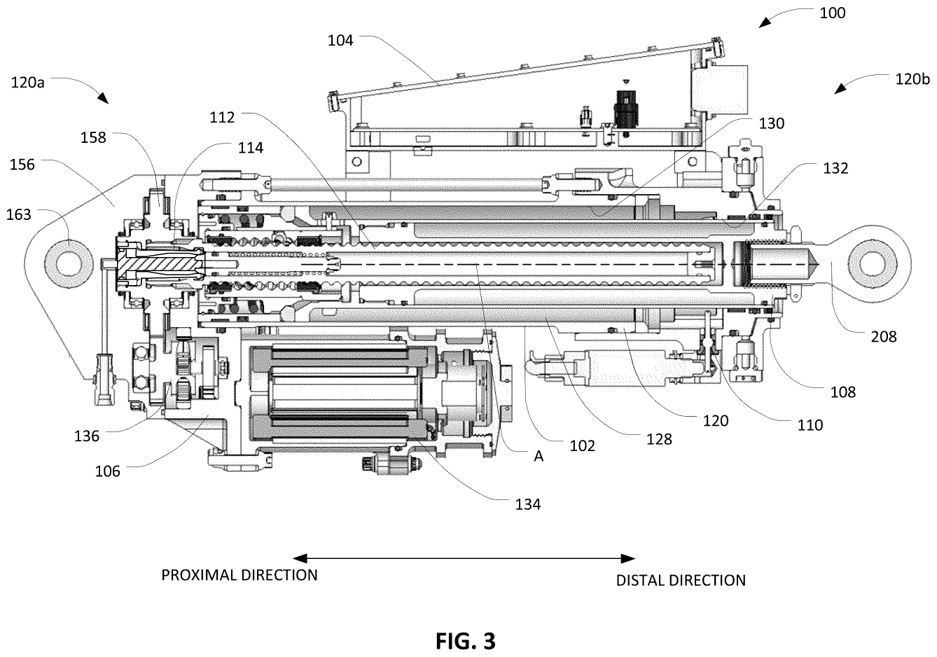

The actuator housing 102 may include an actuator cylinder 120 configured to operably house the piston assembly 108 and the linear drive 112. The depicted actuator cylinder 120 may extend longitudinally between a proximal end 120a and a distal end 120b (see FIG. 3). As used herein, proximal and distal directions extend along the length of the longitudinal axis A of the actuator cylinder 120 and are generally depicted in FIG. 3.

Actuator cylinder 120 may include cylinder sections 122, 124, 126 that are removably attached to one another and cooperatively form a cylinder chamber 128 (see FIG. 3). The cylinder section 122 may be located proximally of the cylinder sections 124 and 126 and may define a relatively large diameter cylinder bore 130 (hereinafter “large cylinder bore 130”), while cylinder section 124 defines a relatively small diameter cylinder bore 132 (hereinafter “small cylinder bore 132”). As will be described in more detail, the piston assembly 108 and the linear drive 112 may be operably received by and supported relative to the actuator cylinder 120 to permit extension and retraction of the piston assembly 108.

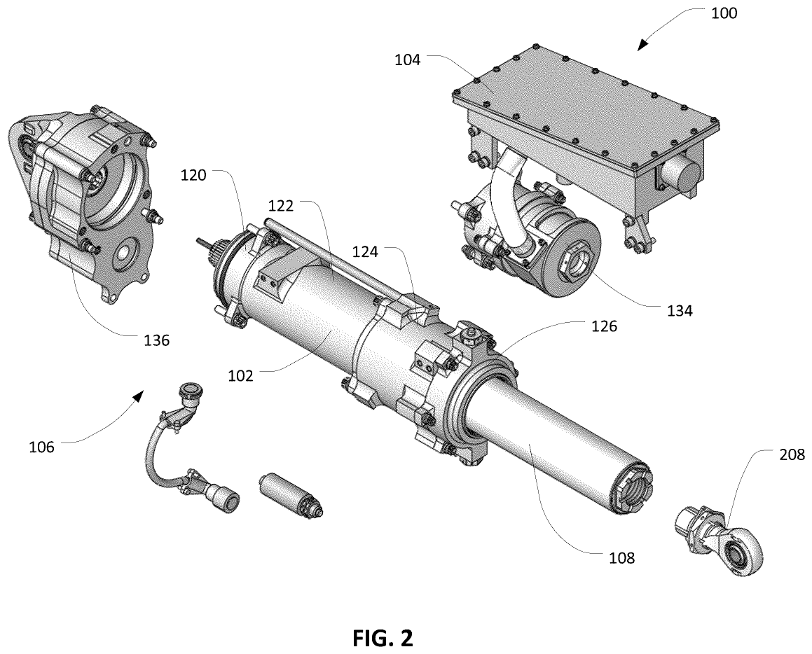

Turning to FIGS. 3-6, the powered drive mechanism 106 is configured to power the linear drive 112 for shifting the piston assembly 108 between a retracted position (see FIGS. 1 and 3) and an extended position (see FIG. 2). Drive mechanism 106 may include rotational drive elements operable to impart rotation to the linear drive 112. Drive mechanism 106 preferably comprises an electromechanical device that is operated via the controller 104. The illustrated drive mechanism 106 may include an electric motor 134 and a transmission 136 powered by the electric motor 134 for shifting the linear drive 112 to extend and retract the piston assembly 108.

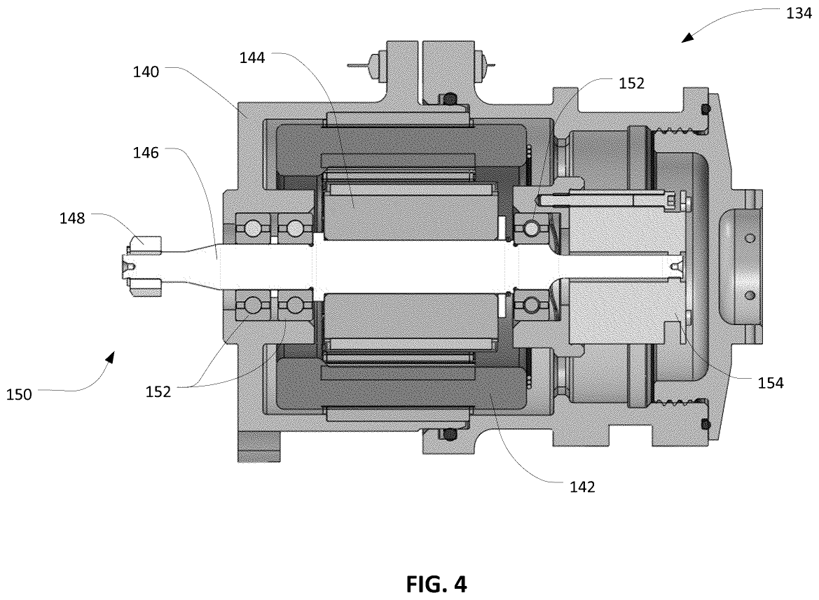

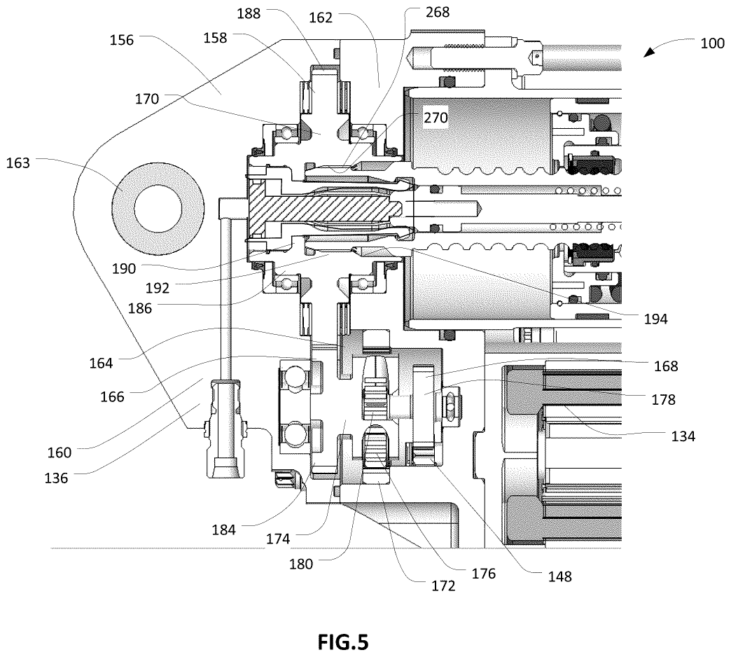

Electric motor 134 may comprise a conventional inner rotor motor including a motor housing 140 that operably receives a stator 142 and a rotor 144 (see FIG. 4). Rotor 144 may include an output shaft 146 and a drive pinion 148 mounted on the output shaft 146 to rotate therewith. Drive pinion 148 may be mounted at an exposed end 150 of the output shaft 146 for driving engagement with the transmission 136 (see FIG. 4). The rotor 144 may be supported by bearings 152 located adjacent respective ends of the stator 142. The electric motor 134 may also include a brake 154 operably attached to the output shaft 146 at an end opposite the drive pinion 148. Brake 154 may be operated to precisely control aspects of motor rotation. For instance, brake 154 may be selectively engaged to reduce the rotational speed of rotor 144 and, in at least some instances, to fully halt rotation of the rotor 144.

In various aspects of the disclosure, embodiments of the actuator may have an alternative electric motor construction. Furthermore, alternative actuator embodiments may include an alternatively powered motor, such as a pneumatic or hydraulic motor.

Because the depicted electric motor 134 includes a rotor shaft that provides the output shaft 146, the electric motor 134 may be devoid of a gear train or other power transmission device for driving the drive pinion 148. However, it is within the scope of at least certain aspects of the disclosure for a motor to include a gear train or other power transmission device that drivingly transfers power from a rotor shaft to an output shaft.

Referring to FIGS. 3, 5, and 6, transmission 136 may be driven by the electric motor 134 and configured to power the linear drive 112 for shifting the piston assembly 108 between retracted and extended positions. Because the transmission 136 may provide an overall gear reduction for the actuator 100, the output rotational speed of the motor 134 may be reduced by the transmission 136 to produce a relatively lower rotational speed for the linear drive 112. Transmission 136 may include a gearbox 156 and a gear drive 158 housed within the gearbox 156.

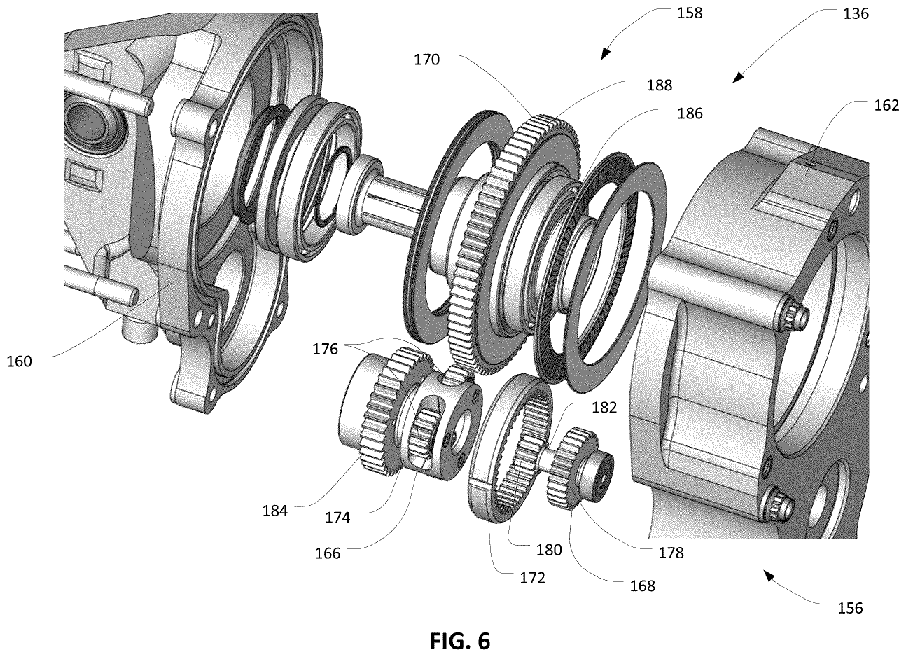

In the illustrated embodiment, the gearbox 156 may include opposed housing sections 160 and 162. Housing section 160 may include a proximal end connector 163. Housing sections 160 and 162 may cooperatively define a transmission chamber 164 (see FIG. 5) to receive the gear drive 158. The gear drive 158 may include a planetary gearset 166, cluster gear 168, and driven bull gear 170 (see FIGS. 5 and 6). Planetary gearset 166 may include a ring gear 172, planet carrier 174, and planet gears 176 rotatably received by the planet carrier 174. Cluster gear 168 may include a driven pinion 178 and a sun gear 180 fixed to a shaft 182 (see FIG. 6). The driven pinion 178 may be drivingly intermeshed with the drive pinion 148 (see FIG. 5), and the sun gear 180 is drivingly intermeshed with the planet gears 176. Furthermore, planet carrier 174 has an integral drive gear 184 drivingly intermeshed with the bull gear 170 (see FIG. 5). Consequently, rotation of the drive pinion 148 of the electric motor 134 produces corresponding rotation of the bull gear 170.

Within the scope of the present disclosure, the transmission may be alternatively configured to provide a gear reduction or to otherwise transmit rotational power to the linear drive. For instance, embodiments of the transmission may include one or more alternative gears or pinions. Transmission embodiments may also have alternative power transmission mechanisms or elements, such as a chain-and-sprocket drive. In at least some embodiments, the actuator may be devoid the transmission 136. For example, the electric motor may include an internal power transmission device that provides a gear reduction.

For at least certain aspects of the disclosure, bull gear 170 may be configured for removable attachment to the linear drive 112. Bull gear 170 may include a hub 186 (see FIG. 5) and gear teeth 188 that encircle the hub 186. The hub 186 may include an interior lip 190 and female splines 192 that extend along and partly define a gear bore 194 (see FIG. 5). As will be described, the depicted gear bore 194 may be operable to receive elements of the linear drive 112 and the releasable coupling 114.

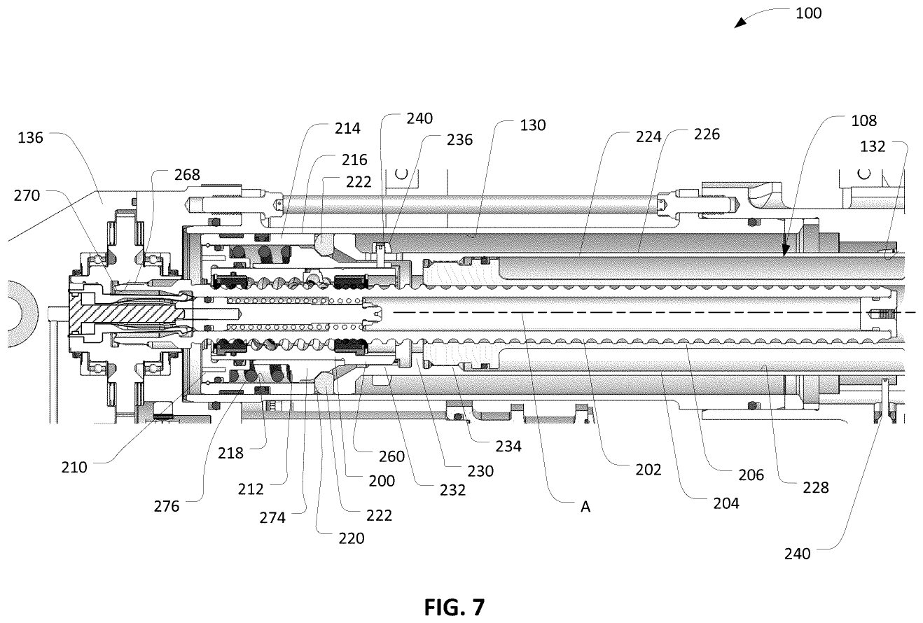

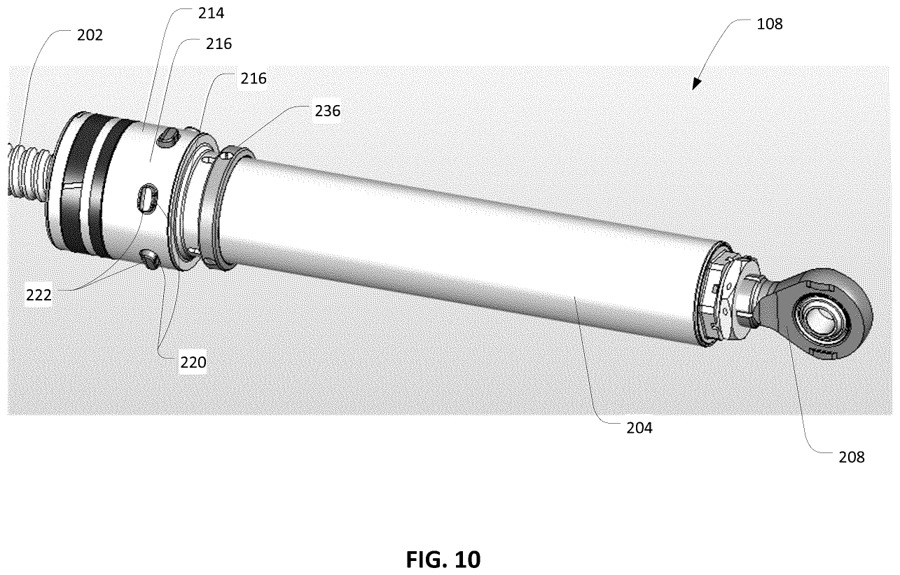

Turning to FIGS. 7-11, the piston assembly 108 may be selectively retracted and extended relative to the actuator cylinder 120 along the axis A (see FIG. 7). As will be explained, the linear drive 112 has a ball nut 200 drivingly mounted on a ball screw 202 (see FIG. 7). Ball nut 200 may be shiftable with the piston assembly 108 between retracted and extended positions by rotating the ball screw 202. The illustrated piston assembly 108 may include an outer piston sleeve 204, an inner piston body 206 located within the piston sleeve 204, a distal end connector 208 (see FIG. 10), a piston end cap 210 (see FIG. 7), and a piston locking device 212.

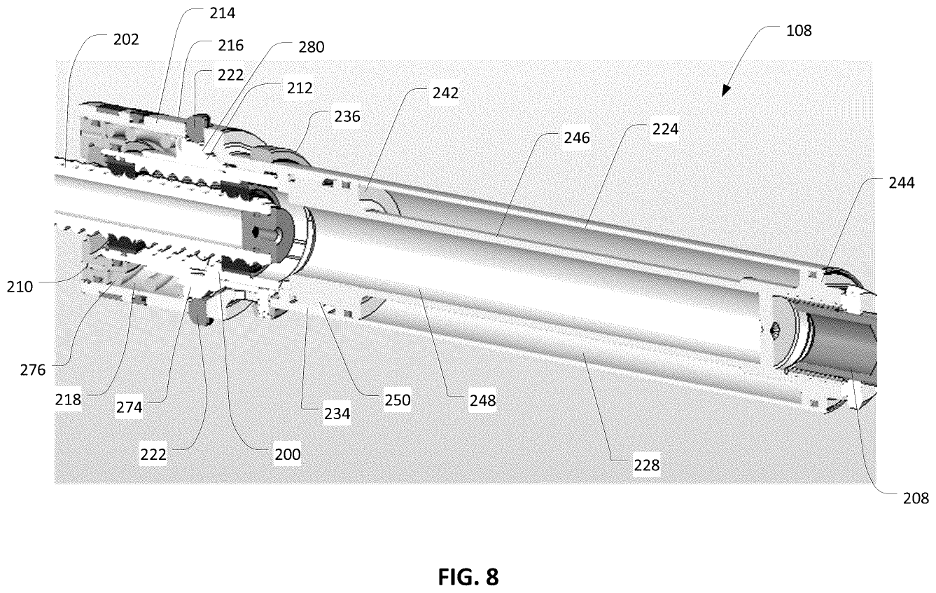

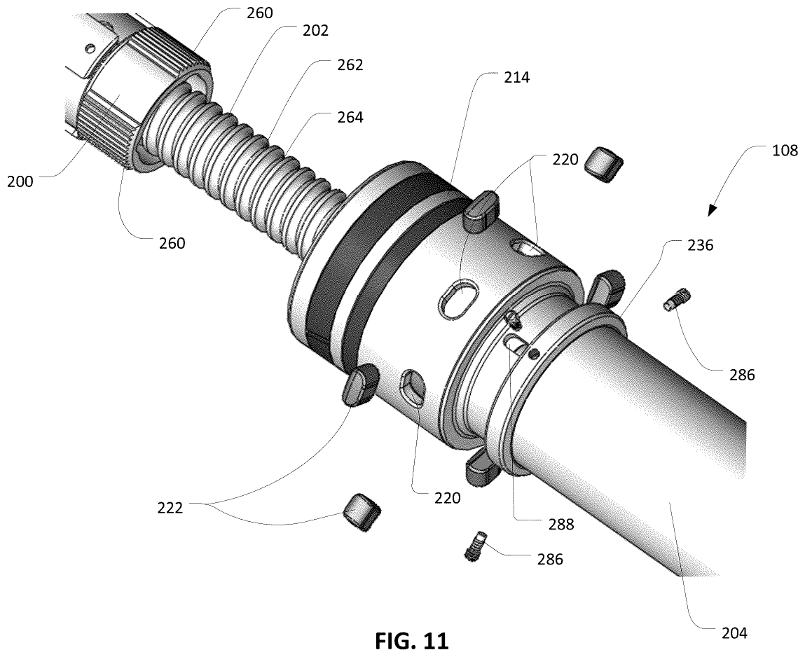

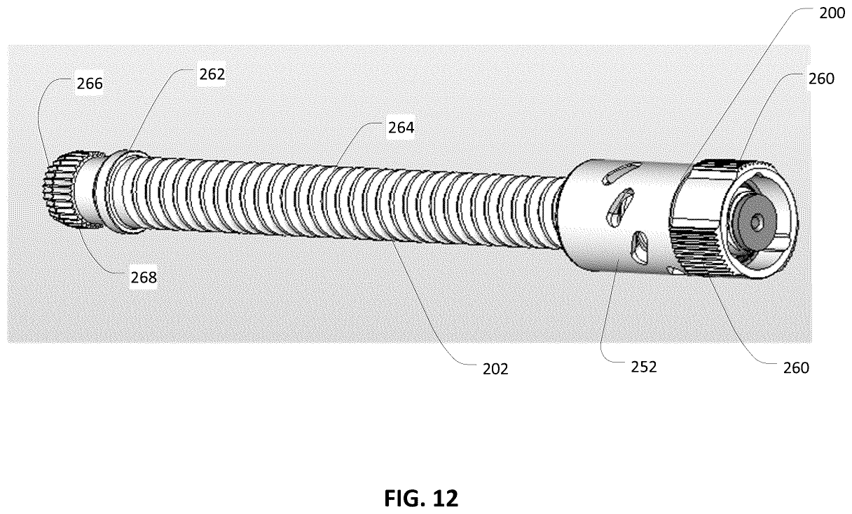

Outer piston sleeve 204 may include a proximal piston section 214 with a proximal outer surface 216 that is configured to be slidably engaged with the large cylinder bore 130 (see FIG. 7). The proximal piston section 214 may also include a proximal piston chamber 218. Proximal piston section 214 may further include a series of circumferentially spaced openings 220 configured to receive piston lock elements 222 (see FIGS. 10 and 11), as will be described. The outer piston sleeve 204 may also include a distal section 224 with a distal outer surface 226 (see FIG. 7) that is configured to be slidably engaged with the small cylinder bore 132. The distal section 224 may also include a distal bore 228, an interior lip 230, proximal female splines 232, and distal female splines 234. A lock ramp indicator ring 236 (see FIGS. 8-11) is preferably mounted on the distal outer surface 226 of the outer piston sleeve 204 and serves as part of a “down-lock” indicator 240 (see FIG. 7), which will be described in more detail below.

Inner piston body 206 may be removably inserted within the distal bore 228 of the outer piston sleeve 204. The inner piston body 206 may include proximal and distal end sections 242 and 244 joined by a tubular section 246 (see FIG. 8). The inner piston body 206 also presents an inner bore 248 extending axially through the proximal end section 242 and the tubular section 246. As will be explained, the inner bore 248 of the inner piston body 206 is configured to slidably receive the ball screw 202 of the linear drive 112 so that the piston assembly 108 is configured to extend and retract relative to the ball screw 202.

The proximal and distal end sections 242 and 244 of the inner piston body 206 may be slidably and sealingly engaged with the distal bore 228 of the outer piston sleeve 204 (see FIG. 8). Proximal end section 242 may also include male splines 250 (see FIG. 8) engaged with the distal female splines 234 of the outer piston sleeve 204 so that the outer piston sleeve 204 and inner piston body 206 rotate with one another.

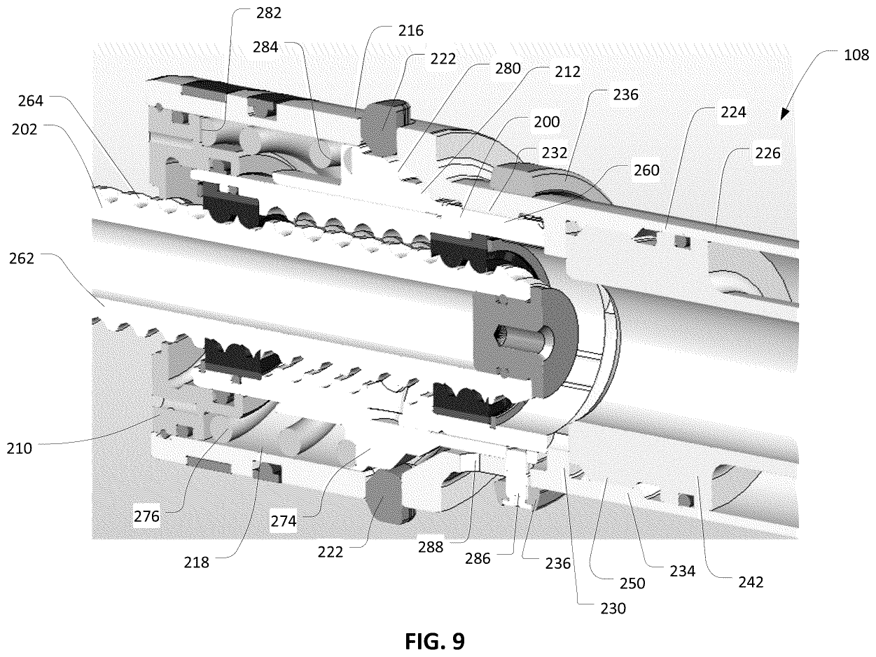

The piston end cap 210 may be positioned at least partly inside the proximal piston chamber 218 of the outer piston sleeve 204 and secured to the proximal piston section 214 of the outer piston sleeve 204 (see FIG. 9). Piston end cap 210 is spaced proximally from the interior lip 230 of the outer piston sleeve 204. Proximal piston chamber 218 extends axially between the piston end cap 210 and the interior lip 230.

The piston end cap 210 is configured to retain the ball nut 200 of the linear drive 112 within the proximal piston section 214 of the outer piston sleeve 204 (see FIG. 9). In particular, the piston end cap 210 and the interior lip 230 of the outer piston sleeve 204 may provide, respectively, proximal and distal stops that cooperatively retain the ball nut 200 within the proximal piston section 214 of the outer piston sleeve 204 and may thereby restrict axial shifting of the ball nut 200 relative to the outer piston sleeve 204. Thus, the ball nut 200 of the linear drive 112 is secured within the proximal piston chamber 218 of outer piston sleeve 204 and is shiftable with the outer piston sleeve 204 relative to the actuator cylinder 120 by rotating the ball screw 202.

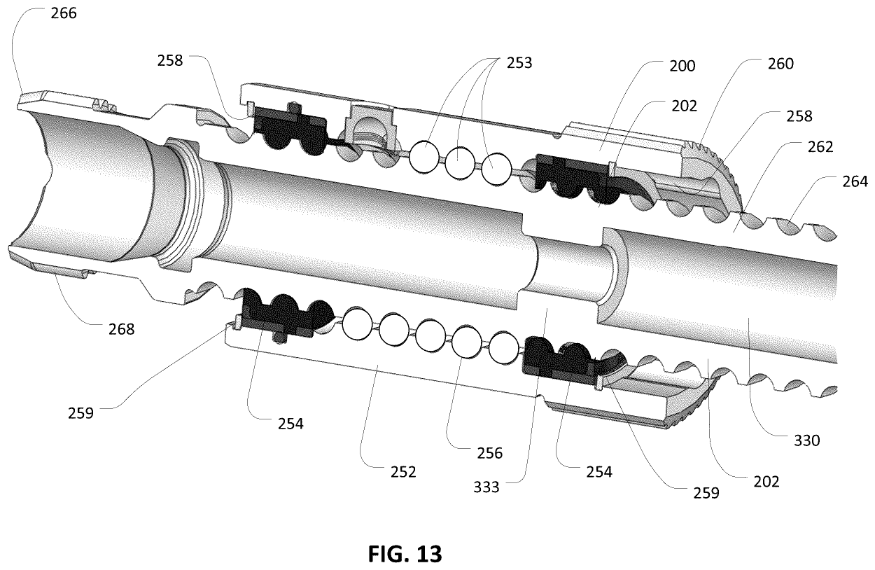

Turning to FIGS. 12 and 13, ball nut 200 may include a tubular body 252 that contains bearing balls 253 (see FIG. 13) and a pair of wipers 254 that extend endlessly about the ball screw 202. In the usual manner, tubular body 252 presents an interior helical thread 256 (see FIG. 13) that may receive the bearing balls 253. The illustrated tubular body 252 presents sockets 258 (see FIG. 13) adjacent each end of the tubular body 252. The depicted sockets 258 may receive the wipers 254. Wipers 254 may be removably secured in the sockets 258 by retaining rings 259 (see FIG. 13). Tubular body 252 of the ball nut 200 may also include male splines 260 (see FIG. 13) configured to drivingly engage proximal female splines 232 of the outer piston sleeve 204 (see FIG. 9) so that the outer piston sleeve 204 restricts rotation of the ball nut 200.

Ball screw 202 may have a unitary construction and may comprise a screw shaft 262 with an exterior helical thread 264 (see FIG. 13). The exterior helical thread 264 may receive the bearing balls 253 so that the bearing balls 253 are captured between the ball screw 202 and ball nut 200. Thus, as the ball screw 202 rotates relative to the ball nut 200, the ball nut 200 is advanced along the length of the ball screw 202. Furthermore, because the ball nut 200 of the linear drive 112 is secured within the proximal piston section 214 of outer piston sleeve 204, the piston assembly 108 may be advanced with the ball nut 200 by rotating the ball screw 202 to extend or retract the piston assembly 108. A proximal end 266 of the ball screw 202 may include male splines 268 (see FIG. 12) operable to be removably, drivingly engaged with female splines 270 of the bull gear 170 (see FIG. 7).

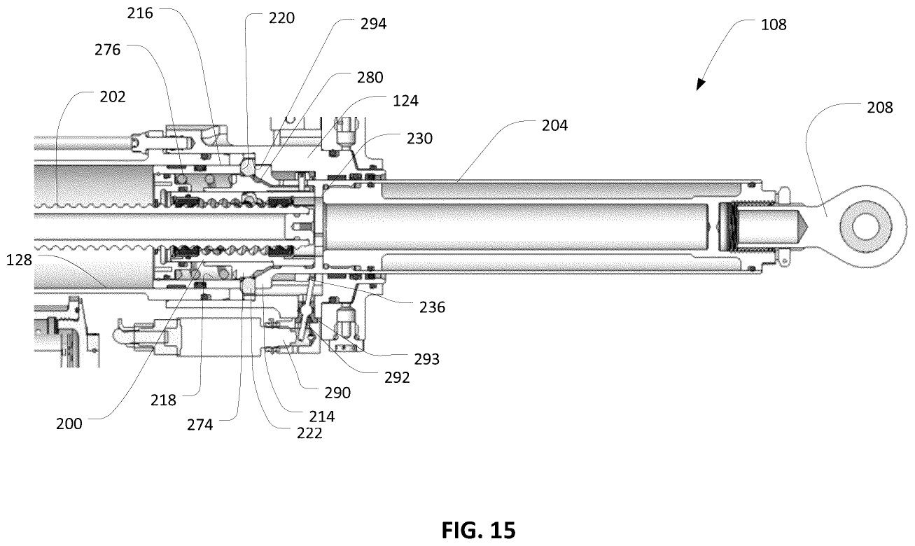

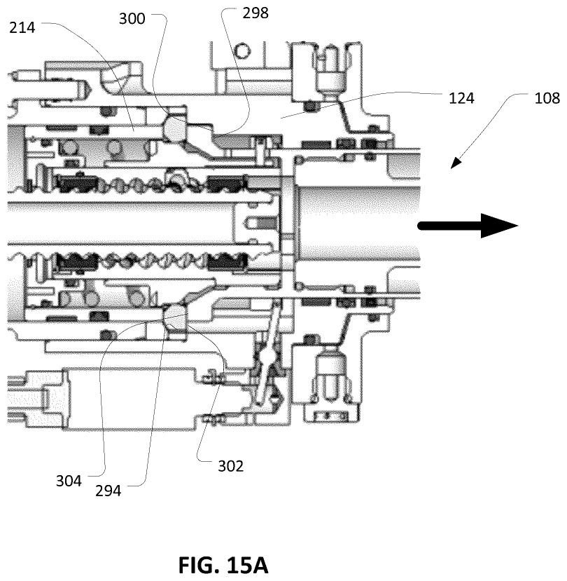

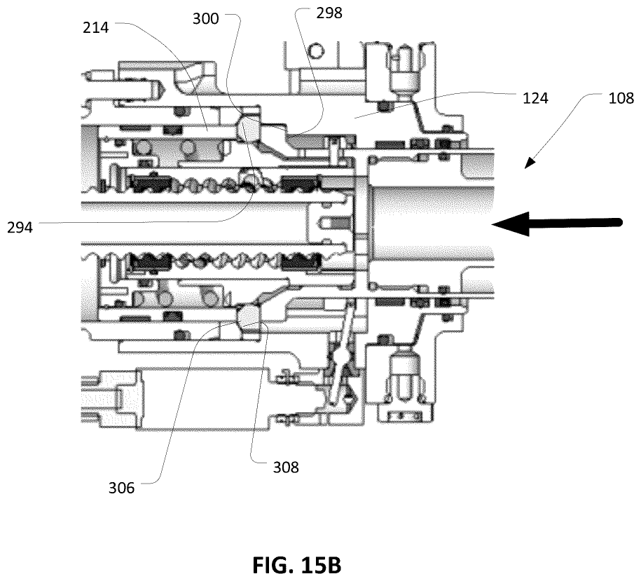

In use, the ball screw 202 of linear drive 112 may be rotated to drive the ball nut 200 and the piston assembly 108 along the axis A. For example, piston assembly 108 may be extended (e.g., from the retracted position or from an intermediate location between the extended and retracted positions) by rotating the ball screw 202 so that the ball nut 200 is advanced distally. In turn, ball nut 200 may be distally shiftable to engage the interior lip 230 (that is, the distal stop) of the outer piston sleeve 204 to move the piston assembly 108 in the distal direction (see FIG. 15).

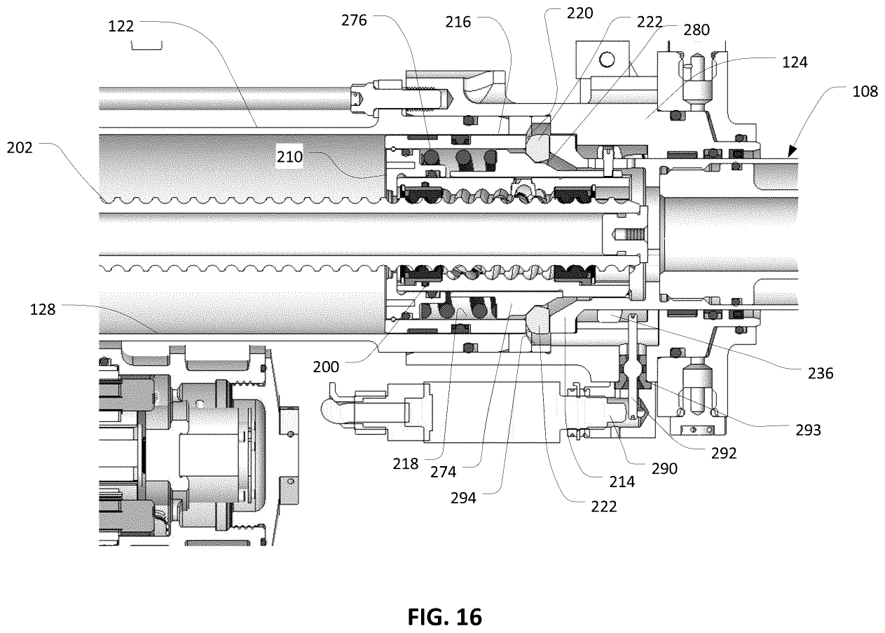

The piston assembly 108 may also be retracted (e.g., from the extended position or from an intermediate location between the extended and retracted positions) by rotating the ball screw 202 so that the ball nut 200 is advanced proximally. Initially, as the ball nut 200 is retracted, the ball nut 200 may disengage from the interior lip 230 (see FIG. 16). The ball nut 200 may be proximally shiftable to engage the piston end cap 210 (that is, the proximal stop) to move the piston assembly 108 in the proximal direction (see FIG. 16).

Referring to FIGS. 7-10, the piston locking device 212 may be housed by the proximal piston section 214 of the outer piston sleeve 204 and configured to removably secure the piston assembly 108 in the extended position (see FIG. 15). In the illustrated embodiment, piston locking device 212 may comprise a spring-loaded mechanism to removably lock the extended piston assembly 108. Piston locking device 212 may include a series of lock elements 222, a shiftable lock ring 274, and a lock spring 276 (see FIGS. 7 and 8).

Lock elements 222 may be moved into and out of a locked position (see FIG. 15) in which lock elements 222 are received in respective openings 220 of the proximal piston section 214 and project radially outwardly relative to the proximal outer surface 216. Lock elements 222 may also be moved into and out of an unlocked position (see FIG. 16) in which lock elements 222 are retracted and located at least partly within the proximal piston chamber 218.

The lock ring 274 and lock spring 276 may be operably located within the proximal piston section 214 (see FIGS. 8 and 9) and may be configured to cooperatively urge the lock elements 222 in a radially outward direction toward the locked position. Lock ring 274 may comprise a unitary tubular structure that is shaped to urge the lock elements 222 radially outward as the lock ring 274 is advanced distally relative to the outer piston sleeve 204. The lock ring 274 may include an endless circumferential projection that tapers to form a lock ramp 280, which is shaped to engage the lock elements 222. In the depicted embodiment, lock ring 274 may be mounted on and fixed to the body of the ball nut 200 so that the lock ring 274 and ball nut 200 move axially with each other between the locked and unlocked positions.

Lock spring 276 may comprise a coil spring positioned between the piston end cap 210 and the lock ring 274 to urge the lock ring 274 toward the locked position (see FIGS. 8 and 9). Specifically, the piston end cap 210 and lock ring 274 present respective shoulders 282 and 284 (see FIG. 9) that are opposed with one another and engage corresponding ends of the lock spring 276. Lock spring 276 may be compressed in the locked and unlocked positions so that the lock ring 274 is urged toward the locked position by the lock spring 276. As the lock ring 274 is advanced distally by the lock spring 276, the lock ramp 280 may urge the lock elements 222 in a radially outward direction.

Lock ring 274 may be operably associated with the down-lock indicator 240 to indicate the position of the lock ring 274 relative to the outer piston sleeve 204 (see FIGS. 9 and 11). For instance, down-lock indicator 240 may include the indicator ring 236 and fasteners 286 used to attach the indicator ring 236 to the lock ring 274. The fasteners 286 may extend through respective axial slots 288 defined in the outer piston sleeve 204 to interconnect the lock ring 274 and the indicator ring 236. Thus, indicator ring 236 and lock ring 274 are configured to slide axially with one another as the lock ring 274 moves between the locked and unlocked positions.

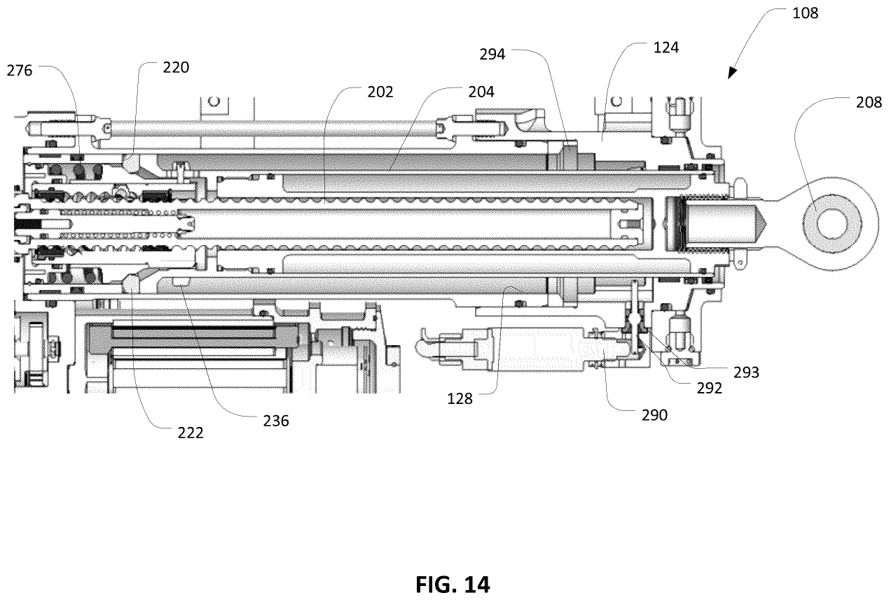

Turning to FIGS. 14-16, the down-lock indicator 240 is configured to provide a signal to the operator that the actuator 100 is locked in the extended position. For instance, down-lock indicator 240 may provide a signal to the operator when the piston assembly 108 is shifted from the retracted position (see FIG. 14) to the extended position (see FIG. 15).

Again, down-lock indicator 240 may include the indicator ring 236 and fasteners 286. Down-lock indicator 240 may also include a down-lock switch 290, a switch lever 292, and a bushing 293 (see FIG. 14). The switch lever 292 may be supported by the bushing 293 within the cylinder section 124 and may extend radially into and out of the cylinder chamber 128. The depicted switch lever 292 may be normally held by the bushing 293 in a neutral position (see FIGS. 14 and 16). For instance, when the switch lever 292 is disengaged from the indicator ring 236, the switch lever 292 may return to the neutral position.

When the switch lever 292 is in the neutral position, the down-lock switch 290 is permitted to return to a normally “off” position (see FIGS. 14 and 16) in which the down-lock indicator 240 provides a signal that the actuator 100 and the landing gear are not extended. When the switch lever 292 is engaged by the indicator ring 236 and pivoted out of the neutral position (see FIG. 15), the switch lever 292 depresses the down-lock switch 290. Consequently, the depressed down-lock switch 290 is shifted by the switch lever 292 into an “on” position (see FIG. 15) in which the down-lock indicator 240 provides a signal to the operator that the actuator 100 and the landing gear are extended.

When the piston assembly 108 is in the retracted position (as well as intermediate positions between the retracted and extended positions) the piston locking device 212 is unlocked and the lock elements 222 are retracted within the outer piston sleeve 204 (see FIG. 14). In the retracted position (see FIG. 14) and in intermediate positions, the large cylinder bore 130 prevents the lock elements 222 from being extended. Again, the piston assembly 108 may be extended by rotating the ball screw 202 so that the ball nut 200 is advanced distally. The ball nut 200 may engage the interior lip 230 of the outer piston sleeve 204 to shift the piston assembly 108 in the distal direction (see FIG. 15).

As the actuator 100 is shifted into the extended position, the lock elements 222 become aligned with an endless circumferential groove 294 formed by the actuator cylinder 120 (see FIG. 15). The groove 294 permits the lock ring 274 to shift distally into a locked position so that the lock elements 222 are moved radially outwardly and into engagement with the groove 294.

When the actuator 100 is locked in the extended position, the illustrated construction of the actuator 100 enables the actuator cylinder 120 and the piston assembly 108 to cooperatively carry an external axial load (such as an axial tension load or an axial compression load applied to the distal end connector 208) without any of the axial load being applied to the ball screw 202 or ball nut 200. That is, the ball screw 202 and ball nut 200 are substantially entirely isolated from the external axial load in the extended position. The piston assembly 108 may be in direct engagement with the actuator cylinder 120 in the extended position to facilitate direct axial load transfer between the piston assembly 108 and the actuator cylinder 120.

For instance, when an axial tension load is applied to the actuator 100 (which urges further extension of the piston assembly 108 from the extended position), a shoulder 298 of the proximal piston section 214 engages a shoulder 300 of the cylinder section 124 (see FIG. 15A). Additionally, distal faces 302 of the lock elements 222 engage a distal shoulder 304 of the groove 294 to prevent extension of the piston assembly 108 (see FIG. 15A). When an axial compression load is applied to the actuator 100 (which urges retraction of the piston assembly 108 from the extended position), proximal faces 306 of the lock elements 222 engage a proximal shoulder 308 of the groove 294 to prevent retraction of the piston assembly 108 (see FIG. 15B).

The piston assembly 108 may be retracted (e.g., from the extended position or from an intermediate location between the extended and retracted positions) by rotating the ball screw 202 so that the ball nut 200 is advanced proximally. Initially, as the ball nut 200 is retracted from the locked position, the ball nut 200 disengages from the interior lip 230 and shifts the lock ring 274 proximally toward the piston end cap 210 (see FIG. 16). With the lock ring 274 shifted proximally, lock elements 222 are permitted to move in a radially inward direction and out of engagement with the groove 294. Having disengaged the lock elements 222 from the groove 294, the piston assembly 108 may be advanced proximally toward the retracted position. In particular, the ball nut 200 may engage the piston end cap 210 (see FIG. 16) and advance proximally with the piston end cap 210 to shift the piston assembly 108 in the proximal direction.

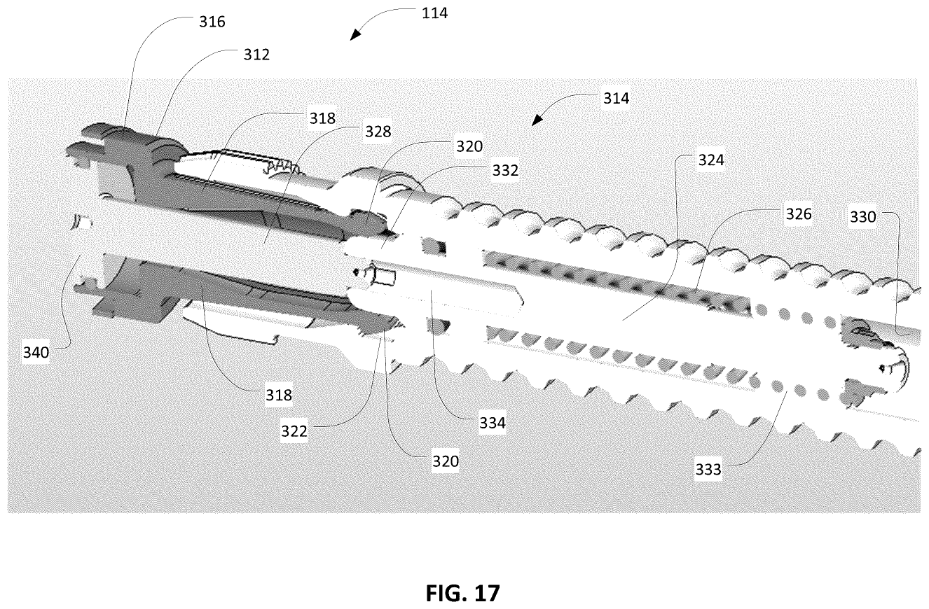

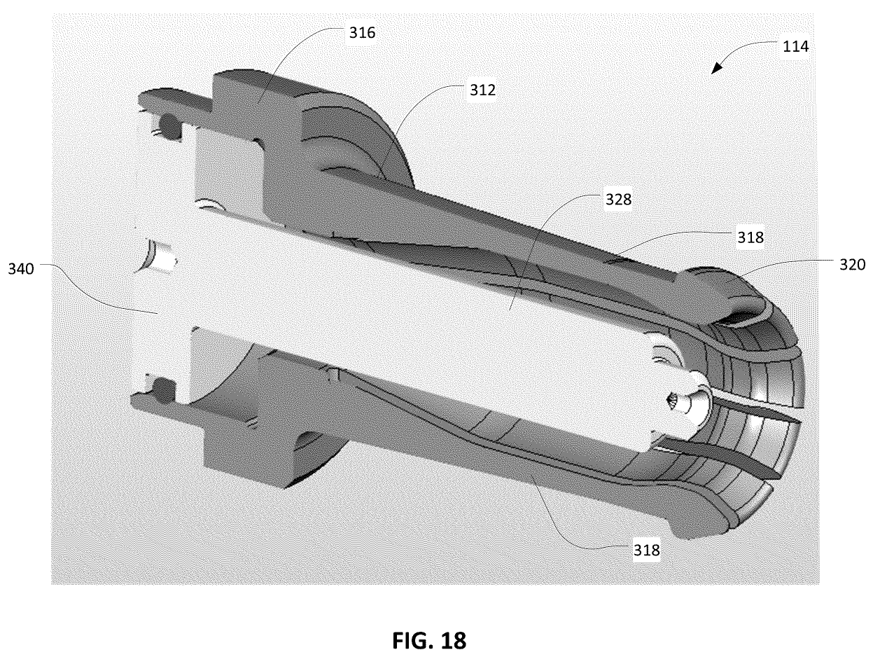

Turning to FIGS. 17-20, actuator 100 is configured to provide secondary (emergency) blow-down operation for extending the landing gear. As noted above, the secondary actuation mode may be provided by a redundant actuator mechanism to ensure reliable extension of the landing gear under adverse conditions that restrict operation of the primary actuator mechanism. For example, activation of the redundant mechanism for extending the landing gear is typically necessary when the primary actuator mechanism experiences some type of failure, such as a power failure or a geartrain failure.

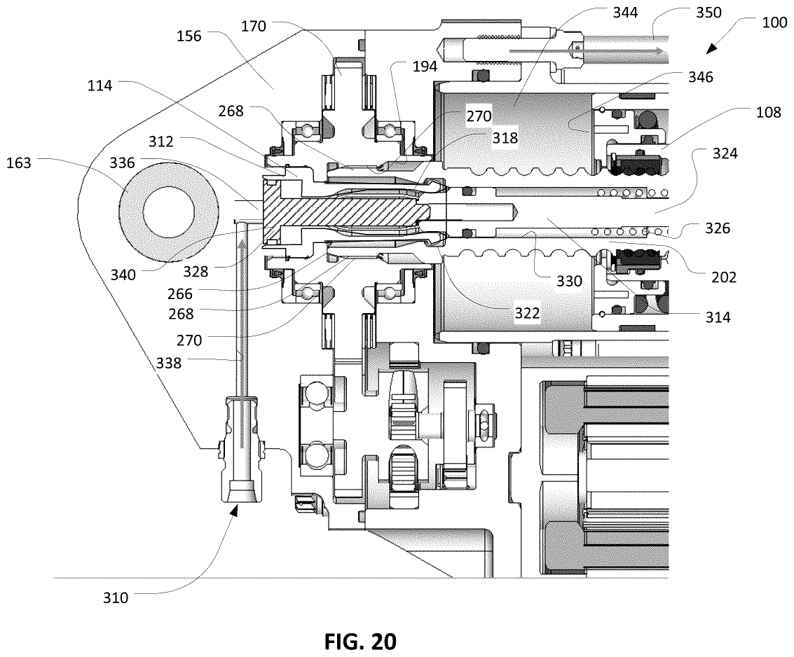

In the illustrated embodiment, the releasable coupling 114 (see FIGS. 17-19) provides part of a secondary actuator mechanism that is operable to permit extension of the piston assembly 108 via pneumatic power (see FIG. 20). It is within the scope of the present disclosure for a pneumatic power source, such as a bottle (not shown) of compressed gas (e.g., nitrogen), to be housed adjacent the actuator 100 for supplying compressed gas to a supply port 310 in the gearbox 156 (see FIG. 20). As will be explained, the releasable coupling 114 may be activated when exposed to compressed gas.

The releasable coupling 114 is configured to removably secure the bull gear 170 and the ball screw 202 in driving engagement with one another (see FIG. 20). This driving engagement may be enabled by positioning the proximal end 266 of the ball screw 202 within the bore 194 of the bull gear 170 so that the male splines 268 of the ball screw 202 engage the female splines 270 of the bull gear 170 (see FIG. 20). In other nonlimiting embodiments of the present disclosure, the ball screw 202 and/or the bull gear 170 may have other coupling elements (such as a complemental key and keyway) for providing removable driving engagement.

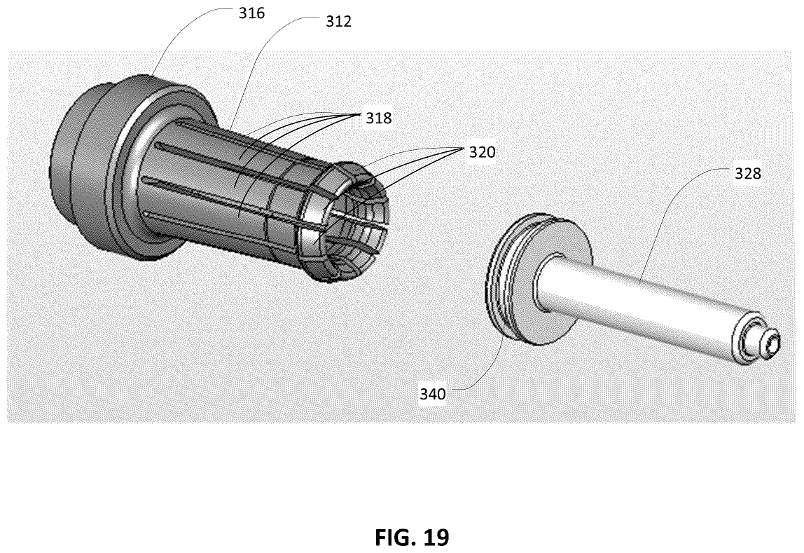

Still referring to FIGS. 17-20, the depicted releasable coupling 114 may include a collet 312 and a complemental collet lock 314 (see FIG. 17). Collet 312 may be operably supported by the bull gear 170 for removable engagement with the ball screw (see FIGS. 17 and 20). Collet 312 includes a head 316 and a plurality of fingers (or tines) 318 (hereinafter “fingers 318”) that project distally relative to the head 316 (see FIG. 19). The fingers 318 are arranged circumferentially and each present a distalmost catch 320.

The catches 320 are configured to cooperatively hold the ball screw 202 in engagement with the bull gear 170 by removably engaging an annular interior groove 322 (see FIG. 17) presented by the ball screw 202. However, each finger 318 is configured to be yieldably flexible so that the distalmost catches 320 may be shifted radially inward to permit distal separation of the ball screw 202 relative to the collet 312.

The collet lock 314 may be configured to removably lock the collet 312 in engagement with the ball screw 202 (see FIG. 17). As will be described, pressurized gas may be used to release the collet lock 314 and thereby facilitate disengagement of the collet 312 and ball screw 202. Collet lock 314 may include a lock pin 324, lock spring 326, and a plunger 328 (see FIG. 17).

Lock pin 324 is slidably mounted in a bore 330 of the ball screw 202 and presents a proximal head 332 that removably engages the fingers 318 in a collet lock position (see FIG. 17). Lock spring 326 is operably received on the lock pin 324 to extend between and engage the proximal head 332 and an integral stop 333 of the ball screw 202 (see FIG. 17). In the collet lock position, the lock spring 326 may be compressed to urge the lock pin 324 into engagement with the fingers 318 of the collet 312 (see FIG. 17). However, lock spring 326 may be further compressed to permit distal shifting of the lock pin 324 out of the collet lock position.

The plunger 328 may be configured to engage and shift the lock pin 324 distally for unlocking the collet 312. The lock pin 324 presents a hole 334 that extends axially through the proximal head 332 to receive a distal end of the plunger 328 (see FIG. 20). Plunger 328 extends proximally through the collet 312 and is positioned adjacent a discharge opening 336 associated with a gas supply passage 338 (see FIG. 20).

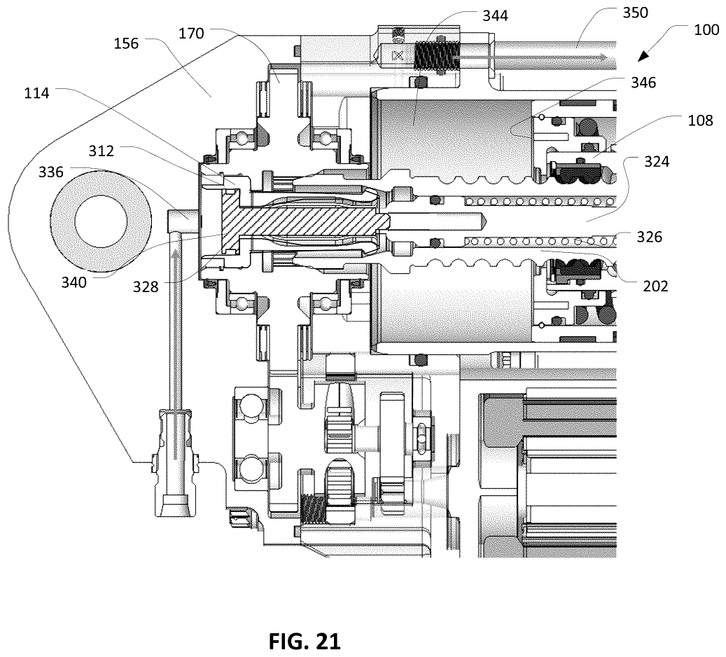

When the pneumatic power source is activated to supply pressurized gas to the actuator 100, gas travels through the supply port 310, gas supply passage 338, and discharge opening 336 (see FIG. 20). Pressurized gas is applied against a plunger head 340 of the plunger 328 (see FIG. 20). Gas pressure applied to the plunger head 340 pushes the plunger 328 and the lock pin 324 distally out of the collet lock position so that the collet 312 is unlocked (see FIG. 21). Distal shifting the plunger 328 and lock pin 324 may push the ball screw 202 distally out of driving engagement with the bull gear 170. Separation of the ball screw 202 and bull gear 170 may open a path for pressurized gas to flow from the discharge opening 336 into a proximal chamber section 344 of the cylinder chamber 128 (the proximal chamber section 344 may be defined proximally of the piston assembly 108). Pressurized gas within the proximal chamber section 344 may apply pressure against a proximal end 346 of the piston assembly 108 and push the piston assembly 108 distally toward the extended position.

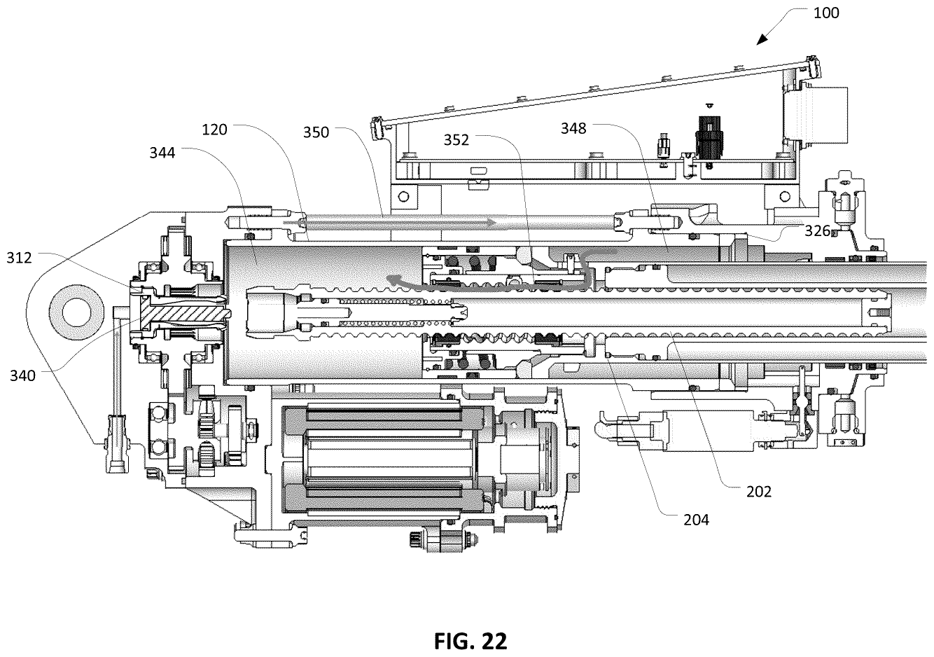

Referring to FIGS. 20-23, embodiments of the actuator 100 are configured to provide a gas bleed mechanism that facilitates snubbing of piston velocity as the piston assembly 108 extends during secondary blow-down operation of the actuator 100. Snubbing of piston extension may be facilitated by a back pressure in a distal chamber section 348 (see FIG. 22). The distal chamber section 348 is defined between the actuator cylinder 120 and the outer piston sleeve 204.

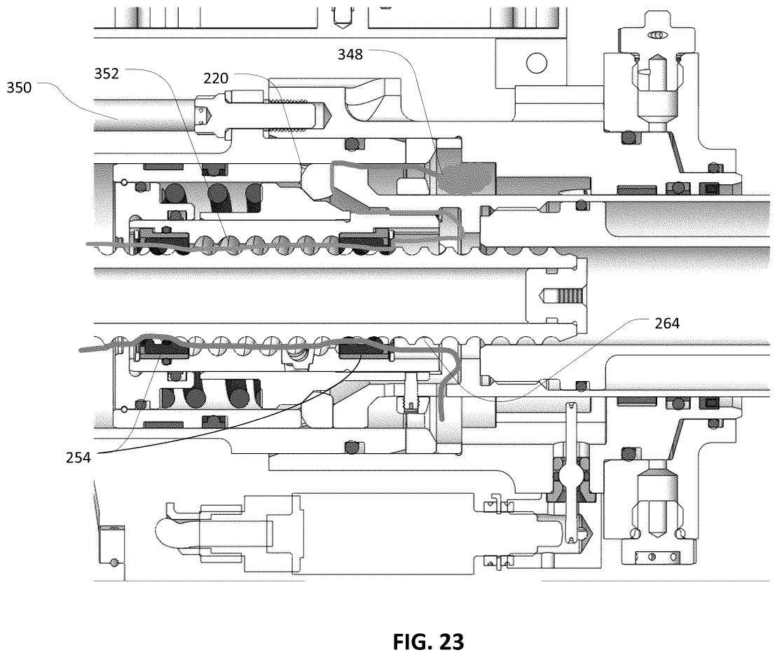

Distal chamber section 348 fluidly communicates with a transfer tube 350 and gas supply passage 338. That is, pressurized gas within the gas supply passage 338 may travel through the transfer tube 350 and into the distal chamber section 348. As the piston assembly 108 shifts distally, the volume of the distal chamber section 348 decreases (see FIG. 23), which may increase the back pressure in the distal chamber section 348.

The distal chamber section 348 may also fluidly communicate with a gas bleed path 352 (see FIGS. 22 and 23) so that pressurized gas may escape from distal chamber section 348 as the piston assembly 108 is fully advanced to the extended position (see FIG. 23). Embodiments of the gas bleed path 352 may be at least partly defined by the ball nut 200. The gas bleed path 352 may permit a restricted flow of pressurized gas to bleed from the distal chamber section 348 to the proximal chamber section 344.

Gas bleed path 352 may extend from the distal chamber section 348, through the slots 288, and through the ball nut 200 into the proximal chamber section 344. The construction of ball nut 200 may provide a flow restriction along gas bleed path 352 so that gas pressure may build in the distal chamber section 348. Wipers 254 and the exterior helical thread 264 may be positioned in sliding engagement with each other but may not form an air-tight seal. Again, the wipers 254 and the exterior helical thread 264 cooperatively retain the bearing balls 253 between the ball nut 200 and the ball screw 202. At the same time, wipers 254 may permit relative rotational movement between the ball nut 200 and ball screw 202. Because the engagement between wipers 254 and the ball screw 202 does not comprise an air-tight seal, the ball nut 200 provides a gas bleed mechanism that permits snubbing pressure in the distal chamber section 348 to bleed through the ball nut 200 and into the proximal chamber section 344. In various embodiments, the wipers 254 may at least partly form a flow restriction that defines a corresponding part of the gas bleed path 352. That is, the wipers 254 may at least partly form a flow restriction that limits pressurized gas bleed axially through the ball nut 200. For instance, the wipers 254 and exterior helical thread 264 of the ball screw 202 may cooperatively form the flow restriction, which defines a corresponding part of the gas bleed path 352. The ball nut 200 may also permit pressurized gas to pass from one side of the proximal piston section 214 to the other side thereof.

It is also within the scope of the present disclosure for the actuator to include one or more alternative mechanisms or elements to permit pressurized gas to escape from the distal chamber section 348 during piston extension. In various nonlimiting examples, one or more alternative flow restrictions may be incorporated as part of the actuator to permit pressurized gas to bleed from the distal chamber section 348 to the proximal chamber section 344, to another interior chamber of the actuator, and/or to a location outside of the actuator.

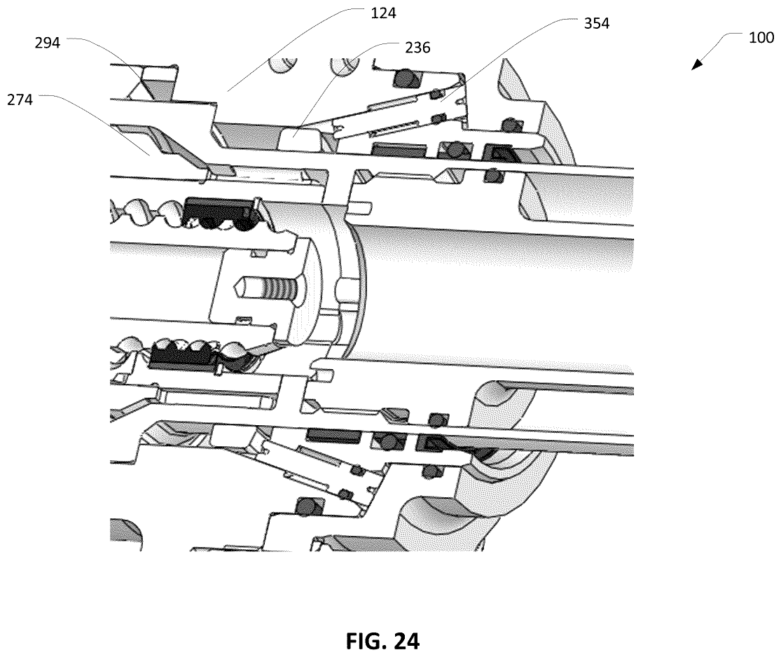

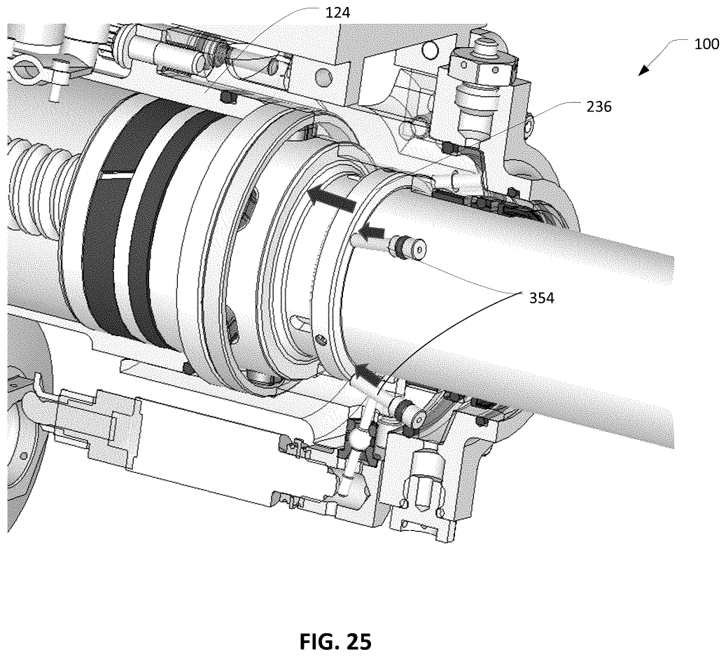

Following an emergency event in which the secondary blow-down operation is used to extend the landing gear, the primary actuation mode may remain disengaged and unable to shift the piston assembly 108 from the extended position. Rather, the actuator 100 may initially require manipulation by a maintenance technician prior to enabling the primary actuation mode. Such a maintenance event (that is, a maintenance process) may include determining the root cause of the failure experienced by the primary actuator mechanism. The maintenance event may also include disengaging the lock elements 222 from the groove 294 so that the piston assembly 108 may be returned from the extended position to the retracted position. The depicted actuator 100 may include one or more lock release pins 354 slidably mounted in the cylinder section 124 (see FIGS. 24 and 25). The lock release pins 354 are configured to engage the indicator ring 236 and shift the indicator ring 236 proximally. This proximal movement of the indicator ring 236 causes corresponding proximal shifting of the lock ring 274 so that the lock elements 222 are permitted to move radially inwardly and out of engagement with the groove 294. Piston assembly 108 and linear drive 112 may then be advanced proximally. Furthermore, the ball screw 202 may be returned to driving engagement with the bull gear 170.

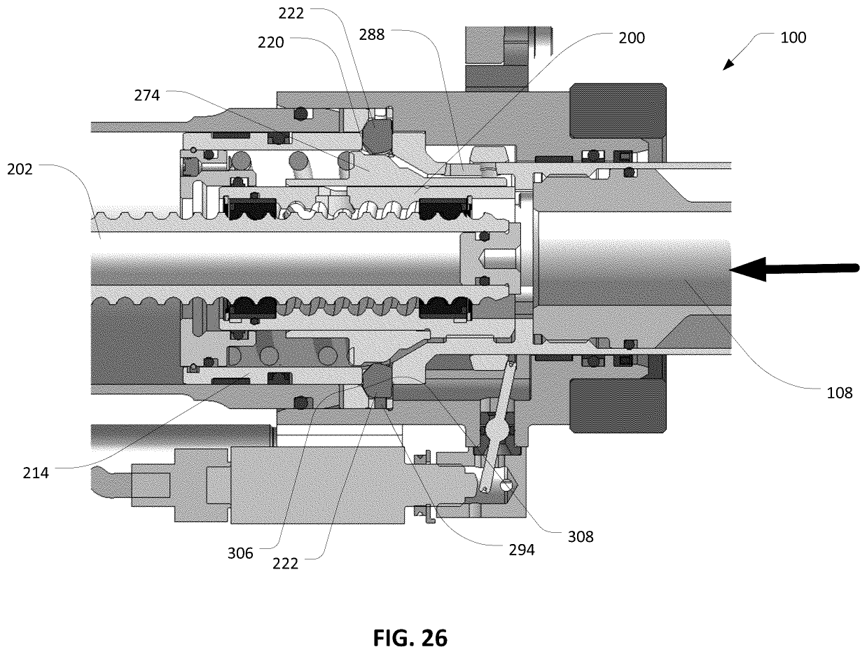

In nonlimiting examples, one or more actuator embodiments may be configured to unlock the piston assembly via an alternative process so as to permit retraction of the piston assembly from the extended position (e.g., where the piston assembly is returned to the primary actuation mode following secondary blow-down operation). For instance, referring to FIGS. 26-31, an alternative piston unlocking process may unlock the piston assembly 108 by utilizing fluid actuation to disengage the lock elements 222 from the groove 294.

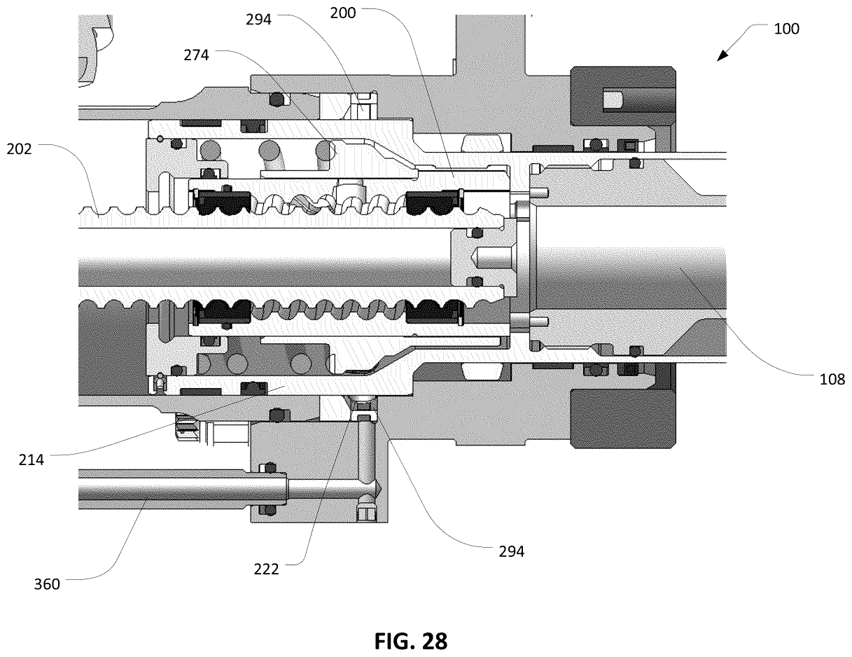

Again, piston assembly 108 may be locked in the extended position by having lock elements 222 engaged with the groove 294 (see FIGS. 26 and 28). As discussed above, when an axial compression load is applied to the actuator 100 (which urges retraction of the piston assembly 108 from the extended position), proximal faces 306 of the lock elements 222 engage a proximal shoulder 308 of the groove 294 to prevent retraction of the piston assembly 108 (see FIG. 26).

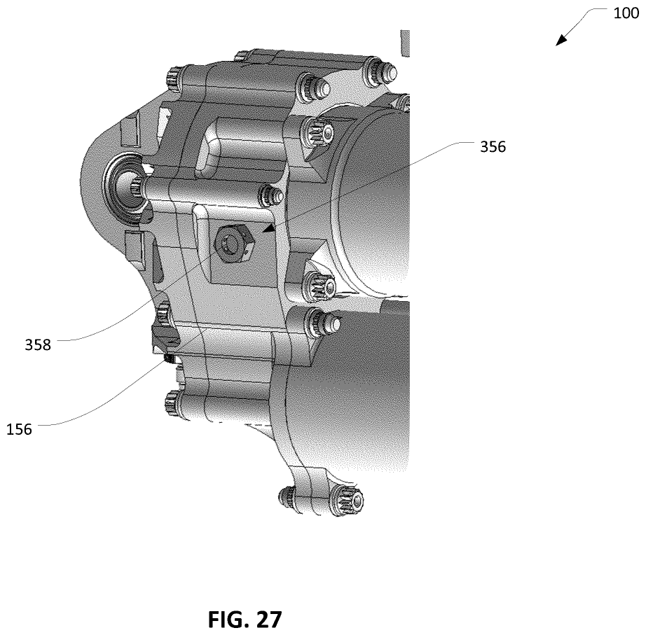

To begin the alternative piston unlocking process, pressure may be vented out of the proximal chamber section 344 and the distal chamber section 348 by opening a vent port 356 (see FIG. 27). For example, the vent port 356, which may be provided by the gearbox 156 (or another housing section of the actuator), may be selectively opened by removing a vent plug 358 (see FIG. 27) from the vent port 356 to vent the proximal chamber section 344 and the distal chamber section 348. With the actuator chambers vented, the vent port 356 may remain open for subsequent steps of the piston unlocking process.

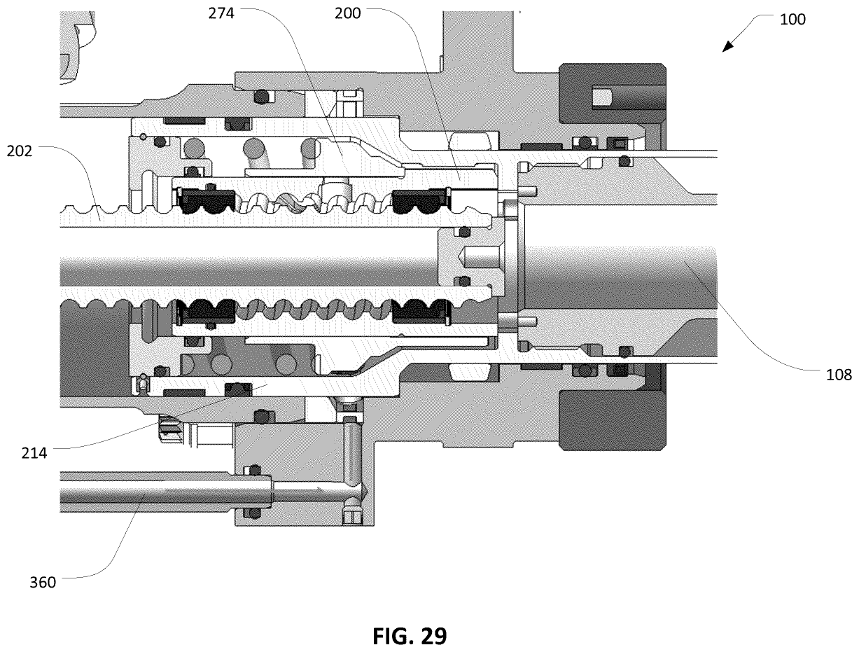

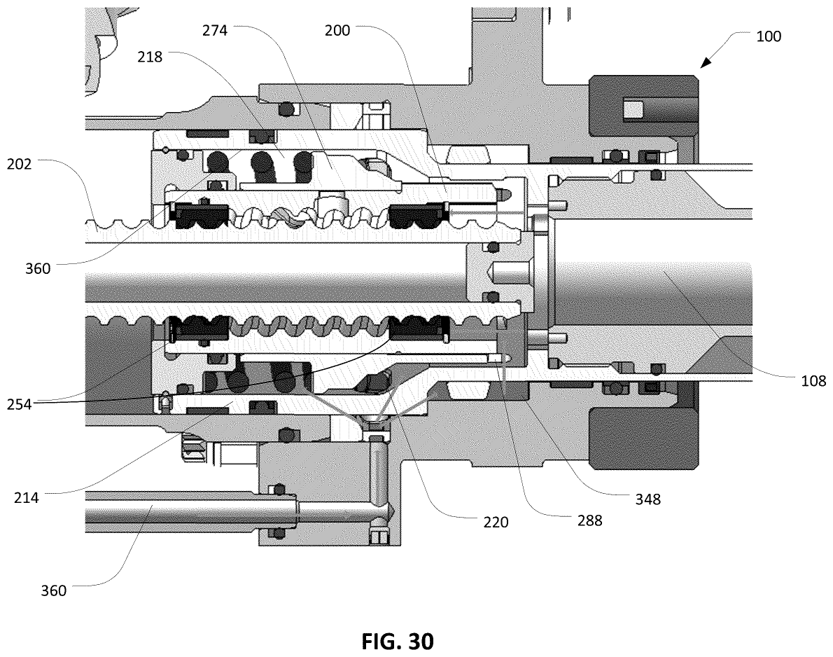

A pressurized gas flow may then be introduced into the actuator 100 via a blow down passage 360 (see FIG. 29). The pressurized gas may flow from passage 360 into the distal chamber section 348 and the proximal piston chamber 218 via openings 220 and slots 288 (see FIG. 30). Pressurized gas may also apply pressure to the distal wiper 254 (see FIG. 30) so as to urge the ball nut 200, ball screw 202, and lock ring 274 proximally within the proximal piston section 214.

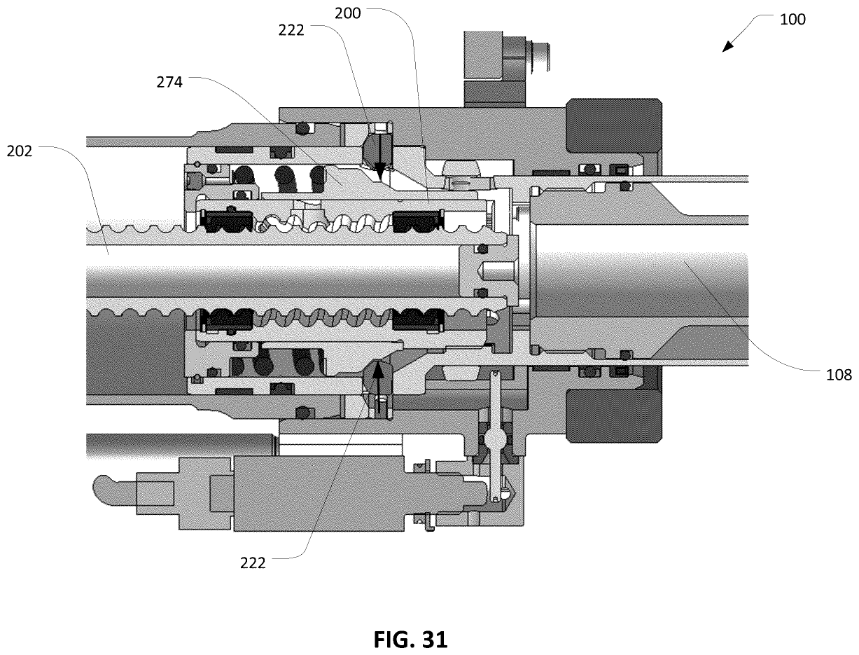

Proximal movement of the ball nut 200, ball screw 202, and lock ring 274 permits the lock elements 222 to move radially inwardly and out of engagement with the groove 294 (see FIG. 31). Piston assembly 108 may then be advanced proximally within the actuator housing. When returning the piston assembly 108 to the primary actuation mode following secondary blow-down operation, the ball screw 202 may be returned to driving engagement with the bull gear 170.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A linear actuator comprising:
a piston slidably mounted for sliding along an axis;
a linear drive including a ball screw and a ball nut operably mounted on the ball screw, with rotation of the ball screw causing the ball nut to move axially along the ball screw,
a drive mechanism including a rotational drive element operable to impart rotation to the ball screw about the axis,
said piston being attached to the ball nut, with the ball nut and piston configured to be advanced along the axis as the ball screw is rotated; and
a releasable coupling that drivingly interconnects the drive mechanism and ball screw, with rotation of the drive element causing rotation of the ball screw,
said coupling releasably attached to one of the drive element and the ball screw to permit relative movement between the drive element and the ball screw.

2. The linear actuator as claimed in claim 1,
said drive element and said ball screw having respective coupling elements that are removably complementally engaged with one another so that the drive element and ball screw are in driving engagement with one another.

3. The linear actuator as claimed in claim 2,
said drive element having a first set of splines and said ball screw having a second set of splines, with the first set of splines and the second set of splines being axially slidable into and out of driving engagement with one another.

4. The linear actuator as claimed in claim 3,
said coupling including a collet,
said collet being operably supported by the drive element and removably attached to the ball screw to restrict relative axial movement between the drive element and the ball screw.

5. The linear actuator as claimed in claim 4,
said collet including fingers slidably received by the ball screw,
said ball screw presenting an annular interior groove, with the fingers engaging the groove to removably attach the collet to the ball screw,
said fingers being yieldably flexible to shift radially inwardly relative to the interior groove to permit separation of the ball screw relative to the collet.

6. The linear actuator as claimed in claim 5,
said coupling including a lock pin slidably received by the ball screw and slidable into and out of engagement with the fingers of the collet to restrict the fingers from flexing out of engagement with the interior groove.

7. The linear actuator as claimed in claim 6,
said coupling including a lock spring that engages the lock pin and urges the lock pin into engagement with the fingers of the collet,
said coupling including a plunger slidably supported and received by the collet,
said plunger being axially slidable relative to the collet to shift the lock pin out of engagement with the fingers of the collet.

8. The linear actuator as claimed in claim 1, further comprising:
an actuator housing that operably receives the piston and permits axial sliding of the piston,
said piston including an outer piston sleeve and a piston locking device housed by the outer piston sleeve,
said piston locking device including lock elements outwardly shiftable into and out of a locked position to extend through the outer piston sleeve and removably engage the actuator housing to restrict axial sliding of the piston relative to the actuator housing.

9. The linear actuator as claimed in claim 8,
said piston locking device including a lock ring housed by the outer piston sleeve, with the lock ring being axially shiftable within the outer piston sleeve to shift the lock elements into the locked position.

10. The linear actuator as claimed in claim 9,
said piston including an indicator ring slidably mounted exteriorly on the outer piston sleeve to slide axially relative thereto,
said indicator ring being attached to the lock ring to indicate whether the lock ring is in the locked position.

11. The linear actuator as claimed in claim 10, further comprising:
a switch mounted relative to the actuator housing to provide a signal to the operator when actuated,
said indicator ring being operably associated with the switch to actuate the switch when the lock ring is in the locked position.

12. The linear actuator as claimed in claim 1,
said drive mechanism including a motor,
said drive element comprising a driven gear powered by the motor.

13. The linear actuator as claimed in claim 1,
said ball nut including a body and wipers attached to the body at opposite ends of the body,
said wipers slidably engaging the ball screw to contain bearing balls between the body and the ball screw, with the wipers at least partly forming a flow restriction that limits pressurized gas bleed axially through the ball nut.

14. The linear actuator as claimed in claim 1,
said piston being slidably mounted for sliding in a distal direction to extend the piston and in a proximal direction to retract the piston;
said piston including a piston section with proximal and distal stops and a piston chamber extending between the proximal and distal stops to receive the ball nut,
said ball nut being distally shiftable to engage the distal stop and move the piston in the distal direction,
said ball nut being proximally shiftable to engage the proximal stop and move the piston in the proximal direction.

15-24. (canceled)

25. A linear actuator comprising:
a linear drive including a ball screw and a ball nut operably mounted on the ball screw,
said ball screw defining an axis, with rotation of the ball screw causing the ball nut to move axially along the ball screw,
a drive mechanism including a rotational drive element operable to impart rotation to the ball screw about the axis,
said ball nut configured to be advanced along the axis as the ball screw is rotated; and
a releasable coupling that drivingly interconnects the drive mechanism and ball screw, with rotation of the drive element causing rotation of the ball screw,
said coupling releasably attached to one of the drive element and the ball screw to permit relative movement between the drive element and the ball screw.

26. The linear actuator as claimed in claim 25,
said drive element and said ball screw having respective coupling elements that are removably complementally engaged with one another so that the drive element and ball screw are in driving engagement with one another.

27. The linear actuator as claimed in claim 26,
said drive element having a first set of splines and said ball screw having a second set of splines, with the first set of splines and the second set of splines being axially slidable into and out of driving engagement with one another.

28. The linear actuator as claimed in claim 27,
said coupling including a collet,
said collet being operably supported by the drive element and removably attached to the ball screw to restrict relative axial movement between the drive element and the ball screw.

29. A process of operating a linear actuator to provide a primary actuation mode and a secondary blow-down actuation mode for extending an aircraft landing gear, said linear actuator having a piston that moves axially to extend and retract the aircraft landing gear, said linear actuator having a linear drive with a ball screw and a ball nut operably mounted on the ball screw, with rotation of the ball screw causing the ball nut to move axially along the ball screw, said piston being attached to the ball nut, with the ball nut and piston configured to be advanced along the axis as the ball screw is rotated, said process comprising:
drivingly engaging a drive element and a ball screw during the primary actuation mode via a releasable coupling, with rotation of the drive element causing rotation of the ball screw and corresponding distal movement of the piston,
releasing the coupling from one of the drive element and the ball screw during the secondary blow-down actuation mode to restrict rotation of the drive element from causing rotation of the ball screw,
supplying pressurized gas to the actuator during the secondary blow-down actuation mode to push the piston distally to extend the aircraft landing gear.

30. The process as claimed in claim 29,
supporting a collet with the drive element and removably attaching a collet to the ball screw during the primary actuation mode to restrict relative axial movement between the drive element and the ball screw.
